(19) United States
(12) Patent Application Publication
(10) Pub. No.: US 2017/0088458 A1
(43) Pub. Date: Mar. 30, 2017

(54) LOW REFLECTIVE GLASS MEMBER AND METHOD FOR PRODUCING LOW REFLECTIVE GLASS MEMBER

(71) Applicant: ASAHI GLASS COMPANY, LIMITED, Chiyoda-ku (JP)

(72) Inventors: Yuichi KUWAHARA, Chiyoda-ku (JP); Yohei KAWAI, Chiyoda-ku (JP); Keisuke ABE, Chiyoda-ku (JP)

(73) Assignee: ASAHI GLASS COMPANY, LIMITED, Chiyoda-ku (JP)

(21) Appl. No.: 15/373,512

(22) Filed: Dec. 9, 2016

Related U.S. Application Data
(63) Continuation of application No. PCT/JP2015/071987, filed on Aug. 3, 2015.

(30) Foreign Application Priority Data
Aug. 4, 2014 (JP) 2014-158523

(51) Int. Cl. C03C 15/00; F21V 3/04; C09D 5/00; C03C 3/089; C03C 3/091

(52) U.S. Cl. CPC C03C 15/00; C03C 3/089; C03C 3/091; C09D 5/006; F21V 3/0418

(57) ABSTRACT

To provide a method whereby a low reflective glass member can be produced efficiently at low cost, and a low reflective glass member. The method for producing a low reflective glass member (10) comprises immersing a glass substrate (12) made of borosilicate glass in an aqueous potassium hydrogencarbonate solution, to form a porous layer (14) at the surface of the glass substrate (12), wherein the temperature of the aqueous potassium hydrogencarbonate solution is preferably from 30 to 90° C., the time for immersing the glass substrate (12) in the aqueous potassium hydrogencarbonate solution is preferably from 0.5 to 24 hours, and the thickness of the porous layer (14) is preferably from 10 to 100,000 nm.

### TECHNICAL FIELD

The present invention relates to a low reflective glass member having reflection of light at the surface suppressed, and a method for producing the low reflective glass member.

### BACKGROUND ART

As a low reflective glass member for the purpose of reducing reflection of light, improving light transmittance, etc., one in which a layer having voids is formed at the surface of a glass substrate to reduce the refractive index of the surface thereby to suppress reflection of light, has been known. However, for such a low reflective member, the production process is cumbersome.

On the other hand, a structure having antifouling and antifogging properties has been proposed in which a network structure layer is formed at the surface of a glass substrate by immersing a glass substrate made of common silicate glass (soda lime glass) in an aqueous potassium hydrogencarbonate solution and etching the surface of the glass substrate (see Patent Document 1).

Patent Document 1 does not disclose that reflection of light is suppressed in the network structure layer of the structure, but discloses that mesh cells of the network structure layer in the structure become gradually smaller in a direction to enter from the surface to the inside. Further, in the production method disclosed in Patent Document 1, in order to form a network structure layer at the surface of a glass substrate, it is necessary to immerse the glass substrate for a long time (e.g. for 7 days) in the aqueous potassium hydrogencarbonate solution.

### PRIOR ART DOCUMENT

### Patent Document

Patent Document 1: JP-A-2013-189351

### DISCLOSURE OF INVENTION

### Technical Problem

It is an object of the present invention to provide a low reflective glass member having a good appearance.

Another object is to provide a method whereby a low reflective glass member having a good appearance can be produced efficiently.

### Solution To Problem

The present inventors have investigated whether or not it is possible to suppress reflection of light by the network structure layer as disclosed in Patent Document 1. However, in the obtained structure, different coloration was observed depending upon the viewing angle or lighting conditions, and reflectance was not sufficiently reduced. It is considered that such appearance problems arose, because the wavelength dependency of reflectance was large with the structure.

The present inventors have conducted further researches on etching techniques by paying attention to differences in glass structures depending upon glass compositions and have finally arrived at the present invention.

The present invention has the following aspects.

[1] A method for producing a low reflective glass member, which comprises immersing a glass substrate made of borosilicate glass in an aqueous potassium hydrogencarbonate solution to form a porous layer at the surface of the glass substrate.

[2] The method for producing a low reflective glass member according to [1], wherein the temperature of the aqueous potassium hydrogencarbonate solution is from 30 to 90° C.

[3] The method for producing a low reflective glass member according to [1] or [2], wherein the time for immersing the glass substrate in the aqueous potassium hydrogencarbonate solution is from 0.5 to 24 hours.

[4] The method for producing a low reflective glass member according to any one of [1] to [3], wherein the concentration of potassium hydrogencarbonate in the aqueous potassium hydrogencarbonate solution is from 0.01 to 5.0 mol/L.

[5] The method for producing a low reflective glass member according to any one of [1] to [4], wherein the thickness of the porous layer is from 10 to 100,000 nm.

[6] The method for producing a low reflective glass member according to any one of [1] to [5], wherein the glass substrate made of borosilicate glass comprises, as represented by mass percentage based on the following oxides,

from 55 to 85% of SiO₂,

from 2 to 30% of B₂O₃,

from 1 to 18% in total of at least one member selected from Li₂O, Na₂O and K₂O, and

from 0 to 5% of Al₂O₃.

[7] A low reflective glass member having a porous layer at the surface of a glass substrate, wherein

the porous layer has an inner surface facing the glass substrate, an outer surface opposed to the inner surface, and a virtual intermediate plane, of which the distance from the inner surface and the distance from the outer surface are equal,

the porosity of the portion from the outer surface to the intermediate plane of the porous layer, is larger by at least 0.1 than the porosity of the portion from the inner surface to the intermediate plane of the porous layer.

[8] The low reflective glass member according to [7], wherein the thickness of the porous layer is from 10 to 100,000 nm.

[9] The low reflective glass member according to [7] or [8], wherein the glass substrate is made of borosilicate glass.

[10] The low reflective glass member according to [9], wherein the borosilicate glass comprises, as represented by mass percentage based on oxides,

from 55 to 85% of SiO₂,

from 2 to 30% of B₂O₃,

from 1 to 18% in total of at least one member selected from Li₂O, Na₂O and K₂O, and

from 0 to 5% of Al₂O₃.

In this specification, the expression “ to ” showing a numerical range is used to include the numerical values set forth before and after it as the lower limit value and the upper limit value, respectively. Unless otherwise specified, in the following specification, the expression “ to ” is used to have the same meaning.

### Advantageous Effects of Invention

The low reflective glass member of the present invention has a low light reflectance and good appearance.

According to the method for producing a low reflective glass member of the present invention, it is possible to produce the low reflective glass member efficiently.

### BRIEF DESCRIPTION OF DRAWINGS

FIG. 1 is a cross-sectional view showing an example of the low reflective glass member of the present invention.

FIG. 2 is a graph of simulation results showing that the wavelength dependency of reflectance becomes small by a porosity inclination in the porous layer.

FIG. 3 is a scanning electron micrograph of a cross section near the surface of the low reflective glass member of the present invention.

FIG. 4 is a scanning electron micrograph of the surface of the low reflection glass member of the present invention.

FIG. 5 is a reflection spectrum at the surface of the porous layer of the low reflective glass member in Ex. 1.

FIG. 6 is a reflection spectrum of the surface of the porous layer of the low reflective glass member in Ex. 2.

### DESCRIPTION OF EMBODIMENTS

In this specification, components of the glass are represented by typical oxides such as SiO₂, B₂O₃, etc., and a glass composition is represented by mass percentage based on oxides. In the following, the mass percentage may be expressed simply by %.

### <Low Reflective Glass Member>

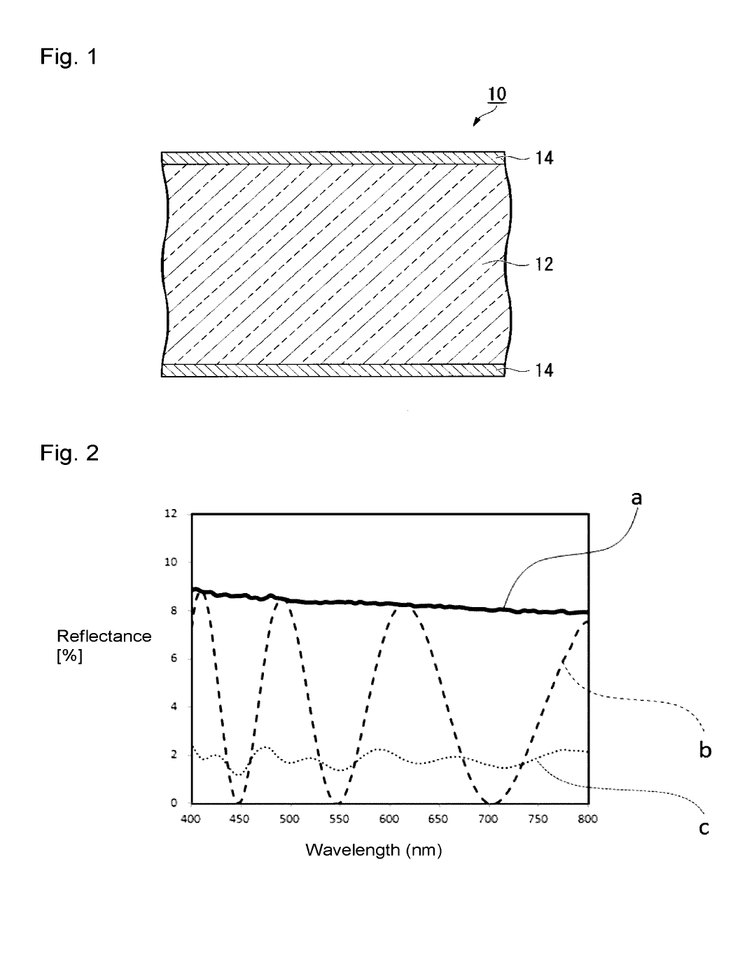

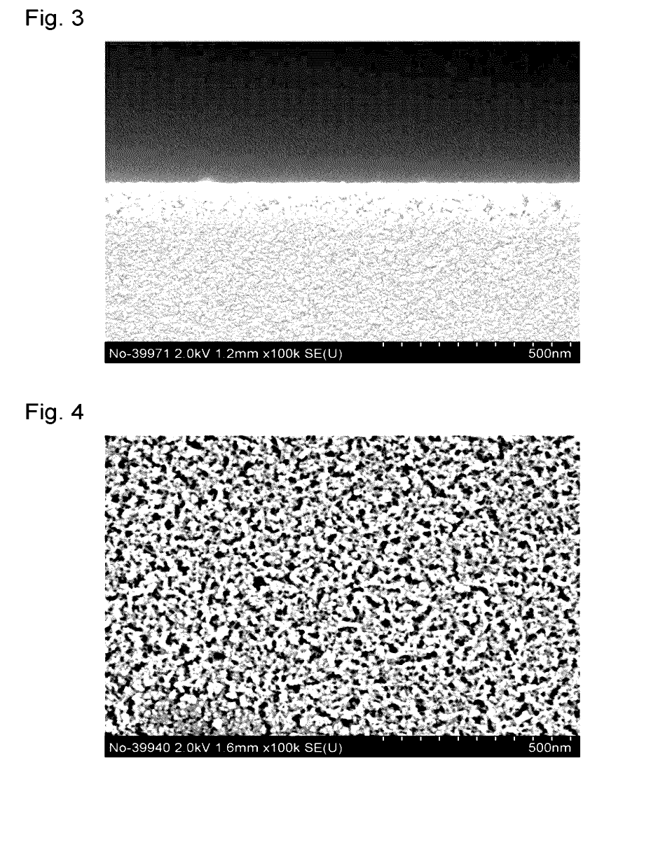

FIG. 1 is a cross-sectional view showing an example of the low reflective glass member of the present invention, FIG. 3 is a scanning electron micrograph of the cross section near the surface of the low reflective glass member, and FIG. 4 is a scanning electron micrograph of the surface of the low reflective glass member. FIG. 2 is a graph of simulation results showing that the wavelength dependency of reflectance varies depending upon a difference in porosity distribution in the porous layer.

Hereinafter, the low reflective glass member of the present invention (hereinafter sometimes referred to simply as the glass member) will be described with reference to the drawings, but the present invention is not limited to the illustrated examples.

For example, the glass substrate may be laminated on another substrate. The porous layer is preferably formed on both sides of the glass substrates, but it may be formed only on one side. A functional layer other than the porous layer may be provided on one side of the glass substrate.

The low reflective glass member 10 has a porous layer 14 at the surface of a glass substrate 12.

The shape of the low reflective glass member 10 may be suitably determined depending upon the application of the low reflective glass member 10, and is usually a plate shape.

In a case where the low reflective glass member 10 is in a plate shape, the thickness may be suitably determined depending on the application, and is usually from 0.05 to 5.0 mm.

The transmittance at a wavelength of 500 nm of the low reflective glass member 10 is preferably at least 94.0%, more preferably at least 96.0%. When the transmittance at a wavelength of 500 nm is at least 94.0%, the low reflective glass member 10 can be suitably used as an optical member.

The reflectance at a wavelength of 500 nm at the surface of the porous layer 14 of the low reflective glass member 10 is preferably at most 6.0%, more preferably at most 4.0%. When the reflectance at a wavelength of 500 nm is at most 6.0%, the low reflective glass member 10 can be suitably used as an optical member. Here, the reflectance is a value obtained by a reflectance measurement wherein the non-light incident side surface is not particularly subjected to blackening treatment, i.e. a total value of reflectance at both surfaces.

(Porous Layer)

The porous layer 14 has an inner surface facing the glass substrate 12, an outer surface opposed to the inner surface, and a virtual intermediate plane, of which the distance from the inner surface and the distance from the outer surface are equal, and the porosity of the portion from the outer surface to the intermediate plane (hereinafter sometimes referred to as “porosity of the outer layer”) is larger by at least 0.1 than the porosity of the portion from the inner surface to an intermediate plane (hereinafter sometimes referred to as “porosity of the inner layer”). The porosity of the outer layer is more preferably larger by at least 0.2 than the porosity of the inner layer. Further, it is preferred that the porosity is inclinedly reduced towards the inner surface from the outer surface. By the presence of refractive index inclination in the porous layer at the glass member surface, the wavelength dependency of the surface reflectance of the glass member becomes small.

The porosity is obtainable by image processing of a scanning electron microscope image of the cross section of the glass member.

The above-mentioned Patent Document 1 discloses a network structure wherein the mesh becomes gradually smaller in a direction towards inside from the surface. However, according to electron microscopic image of the cross-section of the network structure shown in Patent Document 1, the structure looks such that the porosity of the porous layer is substantially uniform.

As compared with the structure in which the porosity becomes gradually smaller in the porous layer, in the structure in which the porosity in the porous layer is uniform, the wavelength dependency of surface reflectance becomes large. This will be explained as follows.

FIG. 2 is a graph showing simulation results of surface reflectance, in a case (b) where no porosity distribution is present in the porous layer and in a case (c) where the porosity becomes gradually large in 9 stages towards inside from the surface, with respect to the case where a porous layer of 1 mm is present at both front side and backside surfaces, by calculating the refractive index at each wavelength, based on actually measured values (a) of the surface reflectance of a soda-lime glass plate having a thickness of 2 mm.

(b) represents the calculation results in the case where a low refractive index layer with a refractive index of 1.23 is present at both front side and backside surfaces of the soda-lime glass plate having a thickness of 2 mm. (c) represents the calculation results in the case where low refractive index layers of the same thickness with refractive indices of 1.23, 1.26, 1.29, 1.32, 1.35, 1.38, 1.41, 1.44 and 1.47, respectively, and with their total thickness being 1 μm, are present from the surface towards inside, at both front side and backside surfaces of the soda-lime glass plate having a thickness of 2 mm.

From FIG. 2, it is seen that when there is an inclination in the refractive index in the porous layer, the wavelength dependency of reflectance becomes small.

If the wavelength dependency of reflectance is large, the wavelength dependency of transmittance also becomes large, whereby only light with a specific wavelength tends to be strongly reflected or to be well transmitted, to cause a reflection color or different coloration depending upon the viewing angle or application conditions of light. Such coloration becomes a problem, for example, in a case where the low reflective member is to be used as e.g. a cover glass for a solid-state image pickup device (such as a CCD image sensor or a CMOS image sensor).

The thickness of the porous layer 14 is preferably from 10 to 100,000 nm, more preferably from 30 to 3,000 nm. When the thickness of the porous layer 14 is at least 10 nm, the reflection of light is suppressed more sufficiently. When the thickness of the porous layer 14 is at most 100,000 nm, the time for immersing the glass substrate in the aqueous potassium hydrogencarbonate solution will not be too long, and the productivity of the low reflective glass member will be better.

The thickness of the porous layer 14 is measured from an image obtained by observing a cross section of the low reflective glass member 10 by a scanning electron microscope.

The porous layer 14 is, for example, one formed by etching the surface portion of the glass substrate 12. In such a case, the porous layer 14 has voids formed by erosion of the glass substrate 12 by the etching solution (e.g. the aqueous potassium hydrogencarbonate solution).

(Glass Substrate)

The glass substrate 12 is made of borosilicate glass.

Borosilicate glass is a glass containing B₂O₃ and SiO₂ as main components and usually containing alkali metal components, and has a glass structure different from soda lime glass containing Na₂O, CaO and SiO₂ as main components, alkali-free glass containing Al₂O₃ and SiO₂ as main components and not containing an alkali metal, or aluminosilicate glass containing Na₂O, Al₂O₃ and SiO₂ as main components.

It is considered that when etching treatment is applied to the glass structure specific to borosilicate glass, a controlled pore structure is formed.

As the borosilicate glass, for example, one having the following glass composition is preferred.

SiO₂: from 55 to 85%,

B₂O₃: from 2 to 30%,

Li₂O+Na₂O+K₂O: from 1 to 18%, and

Al₂O₃: from 0 to 5%.

Further, the following glass composition is preferred.

SiO₂: from 65 to 78%,

B₂O₃: from 8 to 30%,

Li₂O+Na₂O+K₂O: from 1 to 13%,

Al₂O₃: from 0 to 5%, and

CaO: from 0 to 7%.

Now, the preferred glass composition will be described.

SiO₂ is a main component of glass, and it is a component to stabilize glass and is essential. The SiO₂ content is preferably at least 55%, more preferably at least 60%, further preferably at least 65%, in order to increase the weather resistance of the glass member. The SiO₂ content is preferably at most 85%, more preferably at most 78%, further preferably at least 70%, since it is thereby easy to form a porous structure by etching treatment.

B₂O₃ is a network former for forming the glass structure together with SiO₂ and thus is essential. The B₂O₃ content is preferably at least 2%, more preferably at least 5%, further preferably at least 10%, in order to stabilize the glass structure. The B₂O₃ content is preferably at most 30%, more preferably at most 25%, further preferably at most 20%, in order to increase the weather resistance of the glass member.

Li₂O, Na₂O and K₂O are components effective to lower the viscosity of glass and thus to facilitate the production of glass, and at least one of them may be contained. In a case where at least one of Li₂O, Na₂O and K₂O is contained, the total content of Li₂O+Na₂O+K₂O is preferably at least 1%, more preferably at least 2%, further preferably at least 4%, since it is thereby possible to facilitate the etching treatment. The total content of Li₂O+Na₂O+K₂O is preferably at most 18%, more preferably at most 13%, further preferably at most 10%, in order to increase the weather resistance of the glass member.

Al₂O₃ is a component to increase the stability of glass and may be contained. In a case where Al₂O₃ is contained, its content is preferably at most 8%, more preferably at most 5%, further preferably at most 3%, since it is thereby easy to form a porous structure in which the porosity becomes inclinedly smaller from the surface towards inside by etching treatment. When Al₂O₃ is contained, its content is preferably at least 0.1%, more preferably at least 0.5%, in order to increase the stability of glass.

CaO may be contained for the purpose of increasing the stability of glass. When CaO is contained, its content is preferably at most 7%, more preferably at most 5%, in order to make it easy to form a porous structure in which the porosity becomes inclinedly smaller from the surface towards inside by etching treatment. When CaO is contained, its content is preferably at least 0.1%, more preferably at least 0.5%, for the stability of glass.

The borosilicate glass may contain other components to such an extent not to impair the object of the present invention. Such other components may, for example, be MgO, SrO, BaO, ZnO, Li₂O, Fe₂O₃, ZrO₂, TiO₂, Y₂O₃, CeO₂, etc. Further, fining agent components such as SO₃, SnO₂, Sb₂O₃, As₂O₃, etc. may be contained. The total content of such other components is preferably at most 15%, more preferably at most 10%.

(Applications)

Applications of the low reflective glass member obtainable by the production method of the present invention may, for example, be a cover glass for a solid-state image pickup device (such as a CCD image sensor, or a CMOS image sensor), a cover glass for a light-emitting element in an illumination member, a window glass, etc.

### <Method for Producing Low Reflective Glass Member>

The method for producing a low reflective glass member of the present invention is a method which comprises immersing the glass substrate in aqueous potassium hydrogencarbonate solution to etch the surface of the glass substrate thereby to form a porous layer at the surface of a glass substrate.

The aqueous potassium hydrogencarbonate solution may contain other components in addition to potassium hydrogencarbonate, within a range not to impair the object of the present invention.

The concentration of potassium hydrogencarbonate in the aqueous potassium hydrogencarbonate solution is preferably from 0.01 to 5.0 mol/L, more preferably from 0.05 to 3.0 mol/L. When the concentration of potassium hydrogencarbonate is at least 0.01 mol/L, the etching rate of the glass substrate will be sufficiently fast, and the productivity of the low reflective glass member becomes better. When the concentration of potassium hydrogencarbonate is at most 5.0 mol/L, the etching rate will be properly controlled, and it will be possible to carry out etching uniformly.

The temperature of the aqueous potassium hydrogencarbonate solution is preferably from 30 to 90° C., more preferably from 40 to 85° C., further preferably from 50 to 80° C. When the temperature of the aqueous potassium hydrogencarbonate solution is at least 30° C., the etching rate of the glass substrate will be sufficiently fast, and the productivity of the low reflective glass member becomes better. When the temperature of the aqueous potassium hydrogencarbonate solution is at most 90° C., no special apparatus will be required, and it will be possible to easily produce a low reflective glass member.

The time for immersing the glass substrate in the aqueous potassium hydrogencarbonate solution may vary depending on the concentration of potassium hydrogencarbonate, the temperature of the aqueous potassium hydrogencarbonate solution, etc., but is preferably from 0.5 to 24 hours, more preferably from 1 to 18 hours. When the time for immersing the glass substrate in the aqueous potassium hydrogencarbonate solution is at least 0.5 hour, it will be possible to form a porous layer having a sufficient thickness. When the time for immersing the glass substrate in the aqueous potassium hydrogencarbonate solution is at most 24 hours, the productivity of the low reflective glass member will be better.

(Mechanism of Action)

In the method for producing a low reflective glass member of the present invention as described above, (i) the porous membrane to be formed will have voids, whereby the refractive index of the porous membrane will be low, and the reflection of light will be sufficiently suppressed, (ii) the glass substrate is borosilicate glass, whereby it is possible to form a porous layer having a sufficient thickness in a short time at the surface of the glass substrate by the aqueous potassium hydrogencarbonate solution, and (iii) the surface of the glass substrate is etched by an aqueous potassium hydrogencarbonate solution, whereby there is no need to use an expensive material. Therefore, it is possible to produce the low reflective glass member with a high productivity at low cost. Further, (iv) borosilicate glass is subjected to etching, whereby the porous layer is considered to be such that the porosity of the outer layer is larger than the porosity of the inner layer, and as a result, the wavelength dependency of reflectance is small, and it is possible to obtain a low reflective glass member having good appearance.

### EXAMPLES

Hereinafter, the present invention will be described in further detail with reference to Examples, but the present invention is not limited to these Examples.

Ex. 1 and Ex. 3 to 7 are Examples of the present invention, and Ex. 2 and Ex. 8 to 10 are Comparative Examples.

Measurement methods and evaluations of the transmission spectrum, the reflection spectrum, the thickness and porosity of the porous layer, the color change, etc., of the low reflective glass member in each of Ex. 1 to 10, were conducted as follows.

(Transmission Spectrum)

The transmission spectrum of a glass substrate before etching and a low reflective glass member after etching, was measured by a spectrophotometer (model: U-4100, manufactured by Hitachi High-Technologies Corporation). The scanning speed was set to be 1200 nm/min, and as a light source, a 50W tungsten halogen lamp was used. The sample was brought into contact with the integrating sphere, and diffused light was detected also as the transmitted light.

(Reflection Spectrum)

The reflection spectrum at the surface of a glass substrate before etching and a porous layer of a low reflective glass member after etching, was measured by a spectrophotometer (model: U-4100, manufactured by Hitachi High-Technologies Corporation). The scanning speed was set to be 1200 nm/min, and as a light source a 50W tungsten halogen lamp was used. The sample was brought into contact with the integrating sphere, and diffused light was detected also as the reflected light.

(Thickness and Porosity of Porous Layer)

The thickness (physical film thickness) and the porosity of a porous layer, were measured from an image obtained by observing the cross section of a low reflective glass member by a scanning electron microscope (model: S-4300, manufactured by Hitachi, Ltd.).

For the measurement of the porosity, by using an image conversion software (image J), the proportion of voids was obtained with respect to each of the outer layer porosity at outside of 50% in the thickness of the porous layer, and the inner porosity at inside of 50% in the thickness of the porous layer.

(Color Change)

By changing the angle, the reflected color of a glass member was observed, whereby if the color changed, it was judged that there was a color change. There being a color change indicates that the wavelength dependency of reflectance is large.

### Ex. 1

While stirring 95.0 g of deionized water, 5.0 g of potassium hydrogencarbonate (manufactured by Pure Chemical Industries, Ltd.) was added thereto and stirred for 10 minutes at room temperature, to obtain an aqueous potassium hydrogencarbonate solution with a concentration of 0.5 mol/L.

The aqueous potassium hydrogencarbonate solution was heated to 70° C. in a water bath, and a glass substrate (length: 7.5 cm, width: 2.5 cm, thickness: 0.3 mm) made of borosilicate glass was immersed for 2 hours in the aqueous potassium hydrogencarbonate solution to etch the surface of the glass substrate. The glass substrate was taken out from the aqueous potassium hydrogencarbonate solution, rinsed with deionized water and dried to obtain a low reflective glass member having a porous layer formed on the entire surface. Here, the glass composition of the borosilicate glass was SiO₂: 67.8%, B₂O₃: 19.6%, Al₂O₃: 2.8%, K₂O: 8.3%, Na₂O: 0.5%, Li₂O: 1.0%.

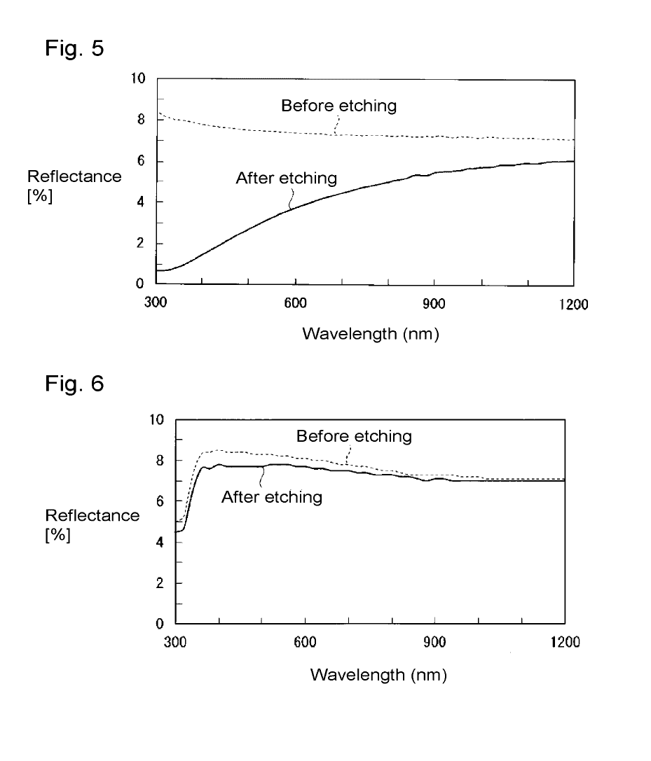

With respect to the low reflective glass member after etching, the transmission spectrum and reflection spectrum were measured. Further, the thickness of the porous layer, the porosity of the outer layer, the porosity of the inner layer, the porosity difference and the color change were measured. The transmittance at a wavelength of 500 nm, the reflectance at a wavelength of 500 nm, the thickness of the porous layer, the porosity of the outer layer, the porosity of the inner layer, the porosity difference and the color change are shown in Table 1. Further, the reflection spectrum is shown in FIG. 5. Further, a scanning electron micrograph of the cross section near the surface of the low reflective glass member obtained in Ex. 1 is shown in FIG. 3, and a scanning electron micrograph of the surface of this low reflective glass member is shown in FIG. 4.

### Ex. 2

In the same manner as in Ex 1, an aqueous potassium hydrogencarbonate solution with a concentration of 0.5 mol/L was obtained.

The aqueous potassium hydrogencarbonate solution was heated to 70° C. in a water bath, and a glass substrate (length: 7.5 cm, width: 2.5 cm, thickness: 2.0 mm) made of soda lime glass was immersed for 2 hours in the aqueous potassium hydrogencarbonate solution to etch the surface of the glass substrate. The glass substrate was taken out from the aqueous potassium hydrogencarbonate solution, rinsed with deionized water and dried to obtain a low reflective glass member having a porous layer formed on the entire surface. Here, the glass composition of the soda-lime glass was SiO_{2: 71.5}%, Al203: 1.8%, K₂O: 0.9%, Na₂O: 12.9%, CaO: 8.7%, MgO: 4.2%.

With respect to the low reflective glass member after etching, the transmission spectrum and reflection spectrum were measured. Further, the thickness of the porous layer, the porosity of the outer layer, the porosity of the inner layer, the porosity difference and the color change were measured. The transmittance at a wavelength of 500 nm, the reflectance at a wavelength of 500 nm, the thickness of the porous layer, the porosity of the outer layer, the porosity of the inner layer, the porosity difference and the color change are shown in Table 1. Further, the reflection spectrum is shown in FIG. 6.

### Ex. 3 to 7

A low reflective glass member having a porous layer formed on the entire surface was obtained in the same manner as in Ex. 1, except that the potassium hydrogencarbonate concentration, the etch temperature and the etching time were changed as shown in Table 1.

With respect to the low reflective glass member after etching, the transmission spectrum and reflection spectrum were measured. Further, the thickness of the porous layer, the porosity of the outer layer, the porosity of the inner layer, the porosity difference and the color change were measured. The transmittance at a wavelength of 500 nm, the reflectance at a wavelength of 500 nm, the thickness of the porous layer, the porosity of the outer layer, the porosity of the inner layer, the porosity difference and the color change are shown in Table 1.

### Ex. 8

A low reflective glass member having a porous layer formed on the entire surface was obtained in the same manner as in Ex. 2, except that the potassium hydrogencarbonate concentration, the etch temperature and the etching time were changed as shown in Table 1.

With respect to the low reflective glass member after etching, the transmission spectrum and reflection spectrum were measured. Further, the thickness of the porous layer, the porosity of the outer layer, the porosity of the inner layer, the porosity difference and the color change were measured. The transmittance at a wavelength of 500 nm, the reflectance at a wavelength of 500 nm, the thickness of the porous layer, the porosity of the outer layer, the porosity of the inner layer, the porosity difference and the color change are shown in Table 1.

### Ex. 9

With respect to a borosilicate glass substrate not subjected to etching treatment, the transmission spectrum and reflection spectrum were measured. Since no porous layer was formed, the thickness of the porous layer, the porosity of the outer layer, the porosity of the inner layer and the porosity difference were not measured. Further, the color change was measured. The transmittance at a wavelength of 500 nm, the reflectance at a wavelength of 500 nm, the thickness of the porous layer, the porosity of the outer layer, the porosity of the inner layer, the porosity difference and the color change are shown in Table 1. Further, the reflection spectrum is shown by a dotted line as “Before etching” in FIG. 5.

### Ex. 10

With respect to a soda-lime glass substrate not subjected to etching treatment, the transmission spectrum and reflection spectrum were measured. Since no porous layer was formed, the thickness of the porous layer, the porosity of the outer layer, the porosity of the inner layer and the porosity difference were not measured. Further, the color change was measured. The transmittance at a wavelength of 500 nm, the reflectance at a wavelength of 500 nm, the thickness of the porous layer, the porosity of the outer layer, the porosity of the inner layer, the porosity difference and the color change are shown in Table 1. Further, the reflection spectrum is shown by a dotted line as “Before etching” in FIG. 6.

TABLE 1

| | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| | Glass substrate | | | | | | | | | |
| | | Soda- | | | | | | Soda- | | Soda- |
| | Borosilicate | lime | Borosilicate | Borosilicate | Borosilicate | Borosilicate | Borosilicate | lime | Borosilicate | lime |
| | glass | glass | glass | glass | glass | glass | glass | glass | glass | glass |
| Concentration | 0.5 | 0.5 | 0.5 | 0.5 | 0.1 | 1.5 | 0.5 | 0.5 | — | — |
| [mol/L] | | | | | | | | | | |
| Etching | 70 | 70 | 30 | 50 | 70 | 70 | 70 | 70 | — | — |
| temperature | | | | | | | | | | |
| [° C.] | | | | | | | | | | |
| Etching time | 2 | 2 | 8 | 2 | 2 | 2 | 24 | 24 | — | — |
| [hr] | | | | | | | | | | |
| Thickness of | 94 | 7 | 82 | 87 | 81 | 89 | 1056 | 302 | 0 | 0 |
| porous layer | | | | | | | | | | |
| [nm] | | | | | | | | | | |
| Porosity of | 0.67 | 0.50 | 0.60 | 0.61 | 0.66 | 0.62 | 0.51 | 0.51 | — | — |
| outer layer | | | | | | | | | | |
| Porosity of | 0.29 | 0.50 | 0.40 | 0.23 | 0.53 | 0.26 | 0.19 | 0.50 | — | — |
| inner layer | | | | | | | | | | |
| Porosity | 0.39 | 0.00 | 0.20 | 0.38 | 0.13 | 0.36 | 0.32 | 0.01 | — | — |
| difference | | | | | | | | | | |
| Transmittance | 97.2 | 92.2 | 97.1 | 96.9 | 96.6 | 95.8 | 98.4 | 99.2 | 93.5 | 91.8 |
| [%] | | | | | | | | | | |
| Reflectance | 2.8 | 7.8 | 2.9 | 3.1 | 3.4 | 3.2 | 1.6 | 0.8 | 7.5 | 8.2 |
| [%] | | | | | | | | | | |
| Color change | No | No | No | No | No | No | No | Yes | No | No |

In the glass member in each of Ex. 1 and Ex. 3 to 7, a porous layer with a sufficient thickness was formed, and in the porous layer, the porosity of the outer layer was larger than the porosity of the inner layer, and reflection of light at the surface of the porous layer was sufficiently suppressed.

In the glass member in Ex. 2, the thickness of the porous layer was insufficient, and the reflectance was high.

In the glass member in Ex. 8, in the porous layer, the difference between the porosity of the outer layer and the porosity of the inner layer was small, whereby the wavelength dependency of reflectance is assumed to be large.

### INDUSTRIAL APPLICABILITY

The low reflective glass member of the present invention is useful as e.g. a cover glass for a solid-state image pickup device (such as a CCD image sensor or a CMOS image sensor), a cover glass for a light-emitting element in an illumination member, a window glass, etc.

This application is a continuation of PCT Application No. PCT/JP2015/071987, filed on Aug. 3, 2015, which is based upon and claims the benefit of priority from Japanese Patent Application No. 2014-158523 filed on Aug. 4, 2014. The contents of those applications are incorporated herein by reference in their entireties.

### REFERENCE SYMBOLS

10: low reflective glass member, 12: glass substrate, 14: porous layer.

What is claimed is:

1. A method for producing a low reflective glass member, which comprises immersing a glass substrate made of borosilicate glass in an aqueous potassium hydrogencarbonate solution to form a porous layer at the surface of the glass substrate.

2. The method for producing a low reflective glass member according to claim 1, wherein the temperature of the aqueous potassium hydrogencarbonate solution is from 30 to 90° C.

3. The method for producing a low reflective glass member according to claim 1, wherein the time for immersing the glass substrate in the aqueous potassium hydrogencarbonate solution is from 0.5 to 24 hours.

4. The method for producing a low reflective glass member according to claim 1, wherein the concentration of potassium hydrogencarbonate in the aqueous potassium hydrogencarbonate solution is from 0.01 to 5.0 mol/L.

5. The method for producing a low reflective glass member according to claim 1, wherein the thickness of the porous layer is from 10 to 100,000 nm.

6. The method for producing a low reflective glass member according to claim 1, wherein the glass substrate made of borosilicate glass comprises, as represented by mass percentage based on the following oxides,
from 55 to 85% of SiO₂,
from 2 to 30% of B₂O₃,
from 1 to 18% in total of at least one member selected from Li₂O, Na₂O and K₂O, and
from 0 to 5% of Al₂O₃.

7. A low reflective glass member having a porous layer at the surface of a glass substrate, wherein
the porous layer has an inner surface facing the glass substrate, an outer surface opposed to the inner surface, and a virtual intermediate plane, of which the distance from the inner surface and the distance from the outer surface are equal,
the porosity of the portion from the outer surface to the intermediate plane of the porous layer, is larger by at least 0.1 than the porosity of the portion from the inner surface to the intermediate plane of the porous layer.

8. The low reflective glass member according to claim 7, wherein the thickness of the porous layer is from 10 to 100,000 nm.

9. The low reflective glass member according to claim 7, wherein the glass substrate is made of borosilicate glass.

10. The low reflective glass member according to claim 9, wherein the borosilicate glass comprises, as represented by mass percentage based on oxides,
from 55 to 85% of SiO₂,
from 2 to 30% of B₂O₃,
from 1 to 18% in total of at least one member selected from Li₂O, Na₂O and K₂O, and
from 0 to 5% of Al₂O₃.
